(19) United States
(12) Patent Application Publication
(10) Pub. No.: US 2012/0119492 A1
(43) Pub. Date: May 17, 2012

(54) Engine-Operated Device for Generating Electricity and a Method for Such

(75) Inventor: Christine Schröter-Hills, Dreieich (DE)

(73) Assignee: ORC ENERGY GMBH, Dortmund (DE)

(21) Appl. No.: 13/100,493

(22) Filed: May 4, 2011

(30) Foreign Application Priority Data
May 5, 2010 (DE) 10 2010 019 580.4

(51) Int. Cl. F02C 6/18

(52) U.S. Cl. 290/2

(57) ABSTRACT

The invention concerns an engine-operated device for generating electricity using an internal combustion engine. The internal combustion engine drives a generator to generate electricity. The exhaust-gas flow of the internal combustion engine is at least partially fed to a turbo generator, in which electricity is also generated. The thermal energy contained in the exhaust-gas flow of the internal combustion engine and/or the turbo generator is utilized for additional generation of electricity and/or utilized as process heat. (Figure)

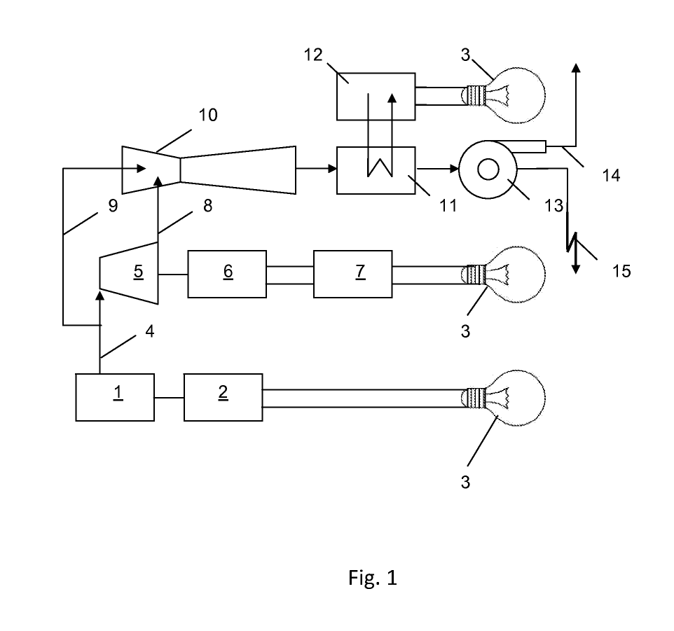

The invention concerns a device and a method for generating electricity using an internal combustion engine that is connected with a generator for generating electricity, and the exhaust-gas line of which is connected with a turbo-generator in order to also generate electricity in the turbo-generator.

It is known from DE 10 2007 048 136 A1 to locate a turbo-generator downstream of an internal combustion engine with exhaust-gas turbo charger, in which some of the energy contained in the exhaust-gas flow is utilized to generate electricity. A similar system was also proposed by the Bowman Power Group Ltd. for increasing the efficiency of electricity generation.

In these types of solutions it is a disadvantage that sometimes the engine management of the internal combustion engine must be engaged in order to be able to operate the additional turbo-generator. In addition, the degree of effectiveness of the electricity generation resulting from the mechanical energy of the internal combustion engine also decreases most of the time.

Further, the exhaust-gas flow downstream of the turbo-generator contains thermal as well as kinetic energy in these types of known systems, which is most often discharged unutilized. For this reason, there is still potential for improvement with respect to the efficiency of devices of this type

In contrast, it is the problem of the present invention to provide a device and method of the type mentioned at the beginning, which makes a further increase in the efficiency of electricity generation possible, preferably with standard industrial components.

According to the invention, this problem is solved with a device that has the characteristics of claim 1. Thereby, it is provided according to the invention that the engine-driven device additionally has a heat exchanger and an electrical generating station that is associated with it. In particular, this can be an electrical generation station that operates according to the Organic Rankine Cycle (ORC), or according to the Clausius Rankine Cycle. For this, the exhaust-gas lines of the internal combustion engine and/or an exhaust-gas line of the turbo-generator is connected with the heat exchanger in such a way, that for the additional electricity generation in the electrical generating station, heat can be released from the exhaust-gas flow of the internal combustion engine and/or the turbo-generator. Thereby, the invention is based on the idea that the thermal energy contained in the exhaust-gas flow of the internal combustion engine and/or the turbo-generator can be utilized for additional electricity generation. Alternatively or in addition to this, the thermal energy can also be utilized as process heat.

According to a preferred embodiment of the invention, a device is located upstream of the heat exchanger that can increase the difference in pressure between the work environment and the exhaust-gas line of the turbo-generator. Preferably, this is a jet pump located upstream of the heat exchanger to which some of the exhaust-gas flow is fed by bypassing the turbo-generator. As a result, the exhaust-gas flow from the turbo-generator is sucked into the jet pump and/or swept along in it. In this way, the overall degree of effectiveness of the device can be improved with technically simple and cost-effective means. Alternatively, or in addition to this, a device can also be provided located downstream of the heat exchanger for increasing the difference in pressure between the work environment and the exhaust-gas line of the turbo-generator. This is, for example, an induced draft located downstream of the heat exchanger, which is preferably actuated electrically.

In a further development of this idea it is provided that the performance of the induced draft is coordinated with the internal combustion engine and/or the turbo-generator in such a way that a reduction of the degree of effectiveness of the internal combustion engine is compensated by the turbo-generator by means of the induced draft. In other words, the induced draft compensates at least some of the counter pressure of the turbo-generator in the exhaust-gas stream of the internal combustion engine. It is thus possible that the internal combustion engine can continue to be operated without losing any degree of effectiveness, even in the case of retrofitting of the turbo-generator. The device in accordance with the invention is thus also suitable for retrofitting existing systems with an internal combustion engine and a generator.

According to a preferred embodiment, a frequency converter is provided that can convert the direct current or alternating current that is generated in the generator, the turbo-generator and/or the electrical generating station into a power supply voltage and power supply frequency, so that it can be supplied to a power grid. Thereby, it is particularly preferred when the electricity generated in the device according to the invention is supplied to a local power grid.

It has been shown to be especially advantageous when the induced draft or similar device for increasing the difference in pressure between the working environment and the exhaust-gas line of the internal combustion engine and/or the turbo-generator is operated with electricity and is fed by a, in particular, public power grid.

According to a preferred embodiment of the invention, the internal combustion engine is a biogas engine or similar engine, the energy source of which is based on renewable raw materials. The internal combustion engine can thereby also be associated with an exhaust-gas turbo charger, which is provided in addition to the turbo-generator. The exhaust-gas turbo charger can further increase the degree of effectiveness of the internal combustion engine.

In a method according to the invention for generating electricity, electricity is generated in a generator using the mechanical energy generated by the internal combustion engine. The exhaust-gas flow of the internal combustion engine is fed at least partially to a turbo-generator in which additional electricity is generated from the kinetic and/or thermal energy contained in the exhaust-gas flow. In accordance with the invention it is thereby provided that, the thermal energy contained in the exhaust-gas flow of the internal combustion engine and/or in the exhaust-gas flow of the turbo-generator, is utilized for generating additional electricity and/or process heat. This preferably occurs by generating additional electricity from the thermal energy contained in the exhaust-gas flow of the internal combustion engine or the turbo-generator in an ORC or a CRC electrical generating station. To do so, the thermal energy can be released from the exhaust-gas flow by means of a heat exchanger, and fed into an ORC or a CRC cycle.

The degree of effectiveness of the method according to the invention can thereby be increased further so that the exhaust-gas flow is sucked in downstream of the turbo-generator by means of a jet pump and/or by means of an induced draft. As a result, the counter-pressure that is to be applied by the internal combustion engine is reduced.

In order to, in particular, be able to operate the ORC or CRC process efficiently, it is preferred when the exhaust-gas temperature downstream of the turbo-generator, i.e. at the exhaust-gas line of the turbo-generator, is at least approximately 400° C.

In the following, the invention is explained in more detail in conjunction with an example of an embodiment and by referring to the enclosed drawing. Thereby, all described and/or illustrated characteristics by themselves, or in any reasonable combination, form the subject matter of the invention independent of the abstract in the claims or their reference.

The single FIGURE shows a schematic diagram of the device according to the invention.

Hereby, an internal combustion engine 1 is provided, which can, for example, be a biogas engine, perhaps with an exhaust-gas turbo charger (not shown). The internal combustion engine 1 is connected with a generator 2, for example, by coupling the output shaft of engine 1 with the input shaft of generator 2. As a result, electricity can be generated when internal combustion engine 1 is operating, which can be supplied to a schematically illustrated consumer 3 or a local and/or public power grid.

The exhaust-gas of the internal combustion engine 1 is partially fed to a turbo charger turbine 5 by an exhaust-gas line 4, which is in turn coupled to a turbo-generator device by a generator 6. Even generator 6 generates electricity during operation, which can likewise be supplied to a consumer 3 or a local grid by means of a frequency converter 7.

The exhaust-gas flow goes from the turbo charger turbine 5 to an exhaust-gas line 8 of the turbo-generator. Further, branching off from the exhaust-gas line 4 of the internal combustion engine 1, a bypass line 9 is provided, by means of which, if necessary by interposing control valves or regulation valves and/or flap valves (not shown), some of the exhaust-gas of the internal combustion engine can be fed to a jet pump 10. The jet pump generates underpressure in the exhaust-gas line 8 of the turbo-generator.

Downstream of the jet pump 10, a heat exchanger 11 is provided, which releases the thermal energy from the exhaust-gas flow and supplies it to an additional electrical generating station 12, for example, an ORC or a CRC electrical power generating station. In it in turn, additional electricity is generated, which can be supplied to a consumer 3 or to a local grid.

According to a preferred embodiment, an induced draft 13 is located downstream of the heat exchanger 11, which can at least partially compensate the decrease in pressure in the exhaust-gas flow caused by the turbo-generator, the jet pump and/or the heat exchanger. From the induced draft 13, the cooled exhaust-gas flow can be released to the work environment by means of a line 14. The induced draft 13 is thereby supplied with energy by means of a schematically indicated electricity source 15. This energy source 15 is preferably the local and/or public power grid to which the electricity that is generated is supplied.

According to a preferred embodiment of the invention, the gas engine 1 is operated with biogas, for example. The electricity generated in generator 2 by engine 1 can be supplied to a local or public grid subject to conditions corresponding to the German Renewable Energy Sources Act (EEG). As those of ordinary skill in the art will recognize, the EEG was designed to encourage cost reductions based on improved energy efficiency as a result of economies of scale over time. The EEG also differentiates between technologies to the extent that each renewable energy source (RES) receives a different payment of a guaranteed price based on its generation cost. For example, a payment of a guaranteed price per kilowatt-hour for hydropower may be different than the price per kilowatt-hour for solar power. This Act is incorporated herein in its entirety by reference, and the reader is directed to it for further information.

The turbo charger turbine 5 that is driven by the hot engine exhaust also generates electricity via its generator 6, which can be supplied at conditions subject to the German Renewable Energy Sources Act. In the case of an excess of engine exhaust-gas, it can be fed into jet pump 10 via bypass line 9. As a result, underpressure is created in the exhaust-gas line 8 of the turbo-generator, which increases the performance of the turbo-generator. An addition of exhaust-gas from internal combustion engine 1 has the additional effect that the exhaust-gas temperature rises downstream of the jet pump 10. It is, for example, approximately 450° C. The exhaust-gas still contains sufficient energy, which can be utilized by means of a heat release as process heat or, as illustrated in the FIGURE, can generate electricity by means of an ORC or a CRC process, which can in turn be supplied at conditions corresponding with the German Renewable Energy Sources Act. Due to induced draft 13, the loss of performance of gas engine 1 is prevented or at least minimized. The energy required for driving induced draft 13 can be obtained from the local/public grid.

### REFERENCE NUMBERS

1 Internal combustion engine
2 Generator
3 Consumer (grid)
4 Exhaust-gas line
5 Turbo charger turbine
6 Generator
7 Frequency converter
8 Exhaust-gas line
9 Bypass line
10 Jet pump
11 Heat exchanger
12 ORC/CRC process
13 Induced draft
14 Exhaust-gas line
15 Electricity source (grid)

1. Engine-operated device for generating electricity with an internal combustion engine, the output shaft of which is connected with a generator for generating electricity, and the exhaust-gas line of which is connected with a turbo-generator in such a way, that the exhaust-gas flow of the internal combustion engine can be fed, at least partially, to the turbo-generator for generating additional electricity, that wherein additionally a heat exchanger and an ORC or CRC electrical generating station that is associated with it are provided, whereby the exhaust-gas line of the internal combustion engine and/or an exhaust-gas line of the turbo-generator are connected with the heat exchanger in such a way, that for the additional generation of electricity in the ORC or CRC electrical generating station, heat can be released from the exhaust-gas flow of the internal combustion engine and/or the turbo-generator.

2. Device according to claim 1, wherein a jet pump is located upstream of the heat exchanger in such a way that some of the exhaust-gas flow of the internal combustion engine is fed to the jet pump, bypassing the turbo-generator.

3. Device according to claim 1, wherein an induced draft is located downstream of the heat exchanger.

4. Device according to claim 3, wherein the performance of the induced draft is coordinated with the internal combustion engine and/or the turbo-generator in such a way, that a reduction of the degree of effectiveness of the internal combustion engine caused by the turbo-generator, is compensated by the induced draft.

5. Device according to claim 1, wherein a frequency converter is located downstream of generator, turbo-generator and or the ORC or CRC electrical generating station.

6. Device according to claim 1, wherein generator, turbo-generator and/or ORC or CRC electrical generating station are associated with means for supplying the electricity generated in them, in particular to a public electricity grid.

7. Device according to claim 3, wherein the induced draft is operated with electricity and is fed, in particular, by a public electricity grid.

8. Device according to claim 1, wherein the internal combustion engine is a biogas engine.

9. Device according to claim 1, wherein the internal combustion engine is associated with an exhaust-gas turbo charger.

10. Method for generating electricity by means of an internal combustion engine that can be operated, in particular, with renewable primary products, whereby from the mechanical energy generated by an internal combustion engine electricity is generated in a generator, and whereby the exhaust-gas flow of the internal combustion engine is fed at least partially to a turbo-generator, in which additional electricity is generated from the kinetic and/or thermal energy contained in the exhaust-gas flow, wherein the thermal energy contained in the exhaust-gas flow of the internal combustion engine and/or the turbo-generator is utilized for generating additional electricity and/or is utilized as process heat.

11. Method according to claim 10, wherein from the thermal energy contained in the exhaust-gas flow of the internal combustion engine and/or the turbo-generator, additional electricity is generated in an ORC or CRC electrical generating station.

12. Method according to claim 10, wherein the exhaust-gas flow downstream of the turbo-generator is sucked in by means of jet pump and/or by means of an induced draft.

13. Method according to claim 10, wherein the electricity generated in generator, turbo-generator and/or the ORC or CRC electrical generating station is supplied to a, in particular, public electricity grid, and that a possibly provided aggregate for improving the degree of effectiveness of the internal combustion engine and/or the turbo generator, in particular the induced draft is operated with electricity, and is fed by this electricity grid.

14. Method according to claim 10, wherein the exhaust-gas temperature downstream of the turbo generator is at least approximately 400° C.
